(19) United States
(12) Patent Application Publication
(10) Pub. No.: US 2009/0272720 A1
(43) Pub. Date: Nov. 5, 2009

(54) METHOD AND HEATING DEVICE FOR FORMING LARGE GRAIN SIZE SILICON MATERIAL STRUCTURE FOR PHOTOVOLTAIC DEVICES

(75) Inventor: JIAN ZHONG YUAN, Simi Valley, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Jian Zhong Yuan, Simi Valley, CA (US)

(21) Appl. No.: 12/433,828

(22) Filed: Apr. 30, 2009

Related U.S. Application Data
(60) Provisional application No. 61/049,432, filed on May 1, 2008.
(60) Provisional application No. 61/049,433, filed on May 1, 2008.

(51) Int. Cl. C03C 25/68; F27B 14/10; F27B 14/14

(52) U.S. Cl. 216/99; 432/81; 432/156

(57) ABSTRACT

A method for forming polysilicon material for photovoltaic cells. A first silicon material characterized by a first purity level is provided. The first silicon material is subjected to a thermal process to transform the first silicon material to a molten state confined in a first spatial volume. The molten first silicon material is subjected to a directional cooling process provided in a second spatial volume for a predetermined period, removing thermal energy from a first region. A polycrystalline silicon material characterized by a second purity level and an average grain size greater than about 0.1 mm is formed from the molten first silicon material in a vicinity of the first region. One or more silicon wafers is formed from the polycrystalline silicon material. A polysilicon film material characterized by a grain size greater than about 0.1 mm is deposited overlying each of the silicon wafers.

### CROSS-REFERENCES TO RELATED APPLICATIONS

This application claims priority to U.S. Provisional Application No. 61/315,470, filed May 1, 2008, and U.S. Provisional Application No. 61/337,245, filed May 1, 2008, both in the name of Jian Zhong Yuan, and hereby incorporate by reference for all purpose.

### BACKGROUND OF THE INVENTION

The present invention is directed to photovoltaic material. More particularly, the present invention provides a method and structure for forming a large grain polysilicon material. Merely by way of example, the present method and structure have been applied to photovoltaic cells, but it would be recognized that the invention may be implemented using other materials.

Increasing population growth and industrial expansion have lead to a large consumption of energy. Energy often comes from fossil fuels, including coal and oil, hydroelectric plants, nuclear sources, and others. Almost every element of our daily lives uses fossil fuel, which is becoming increasingly scarce. Accordingly, other alternative sources of energy have been developed to supplement or to replace energy derived from fossil fuels.

Solar energy possesses many desirable characteristics. Solar energy is renewable, clean, abundant, and often widespread. Certain technologies developed often capture solar energy, store it, and convert it into other useful forms of energy, for example, electrical and/or thermal energy.

Solar devices have been developed to convert sunlight into energy. As merely an example, solar thermal panels often convert electromagnetic radiation from the sun into thermal energy for heating homes, running certain industrial processes, or driving high grade turbines to generate electricity. As another example, solar photovoltaic panels convert sunlight directly into electricity for a variety of applications. Accordingly, solar panels have great benefit to human users. They can diversify our energy requirements and reduce the world's dependence on oil and other potentially detrimental sources of energy.

Although solar devices have been used successful for certain applications, there are still certain limitations. For example, solar cells are often composed of silicon material, which are often costly and difficult to manufacture efficiently on a large scale. These and other limitations are described throughout the present specification, and may be described in more detail below.

From the above, it is seen that techniques for providing photovoltaic silicon bearing materials is highly desirable.

### BRIEF SUMMARY OF THE INVENTION

According to embodiments of the present invention, a method for forming a polysilicon material is provided. More particularly, embodiments according to the present invention provide a method and a structure for a large grain polysilicon material. Merely by way of example, embodiments according to the present invention can be applied to fabrication of photovoltaic devices. But it would be recognized that the present invention has a broader range of applicability.

In a specific embodiment, a method for forming polysilicon material for manufacturing photovoltaic cells is provided. The method includes providing a first silicon material characterized by a solid state and having a first purity level. The method includes heating the first silicon material to a first temperature greater than a melting temperature of the first silicon material to transform the first silicon material to a molten state confined within a first spatial volume. The molten first silicon material is then transferred into a second spatial volume. The second spatial volume is provided using a directional cooling vessel in a specific embodiment. The method includes removing thermal energy from a first spatial region of the directional cooling vessel at a first rate using a cooling process to cause a thermal gradient along a first spatial volume of the directional vessel between the first spatial region to a second spatial region. The thermal gradient is characterized by a first temperature at the first spatial region and a second temperature at the second spatial region at a determined time. The method forms a solid polycrystalline silicon material from a portion of the molten state at a vicinity of the first spatial region, the solid polycrystalline silicon material having a second purity level and an average grain size greater than about 0.1 mm. The method removes the solid polycrystalline silicon material from the first spatial volume of the second spatial volume. The method forms one or more wafers from the polycrystalline silicon material and subjects a surface region of each of the wafer to one or more surface treatment process. Thereafter, a polysilicon film is formed overlying the surface region using a deposition process. The polysilicon film is characterized by a grain size greater than about 0.1 mm in a specific embodiment.

In an alternative embodiment, an apparatus for forming silicon material for photovoltaic devices is provided. The apparatus includes a directional cooling vessel in a specific embodiment. The directional cooling vessel includes a crucible having a first spatial volume and a height. The directional cooling vessel includes a first heating element provided external to the first spatial volume of the crucible in a vicinity to a first spatial region in a vicinity to the first end of the height. The first heating element maintains a first temperature range in the first spatial region of the first spatial volume and a second temperature range in a second spatial region of the first spatial volume. In a specific embodiment, the first temperature range comprises a first temperature greater than about a melting temperature of a silicon material. Preferably, the first temperature range and the second temperature range cause a temperature gradient along the spatial volume between the first spatial region and the second spatial region.

Many benefits are achieved by way of present invention over conventional techniques. For example, the present technique provides an easy to use process that relies upon conventional technology. In some embodiments, the present method provides a polysilicon material that can be a low cost alternative to the conventional polysilicon material used in photovoltaic device application. Additionally, the method provides a process that is compatible with conventional process technology without substantial modifications to conventional equipment and processes. Depending upon the embodiment, one or more these benefits may be achieved. These and other benefits will be described in more detail throughout the present specification and more particularly below.

### BRIEF DESCRIPTION OF THE DRAWINGS

FIG. 1 is a simplified process flow diagram illustrating a method for forming a large grain polysilicon material according to an embodiment of the present invention.

FIGS. 2-8 are simplified diagrams illustrating a method for forming a large grain polysilicon material according to an embodiment of the present invention.

FIG. 9 is a simplified diagram illustrating an apparatus for forming polycrystalline silicon material according to an embodiment of the present invention.

### DETAILED DESCRIPTION OF THE INVENTION

Embodiments according to the present invention are directed to techniques related to photovoltaic materials. More particularly, the present invention provides a method and structure for forming a polysilicon material characterized by a large grain size, for example, greater than about 0.1 mm. Merely by way of example, the present method have been applied to photovoltaic application, but it would be recognized that embodiments according to present invention can have other applications. Further details of the embodiments of the present invention can be found throughout the present specification and more particularly below.

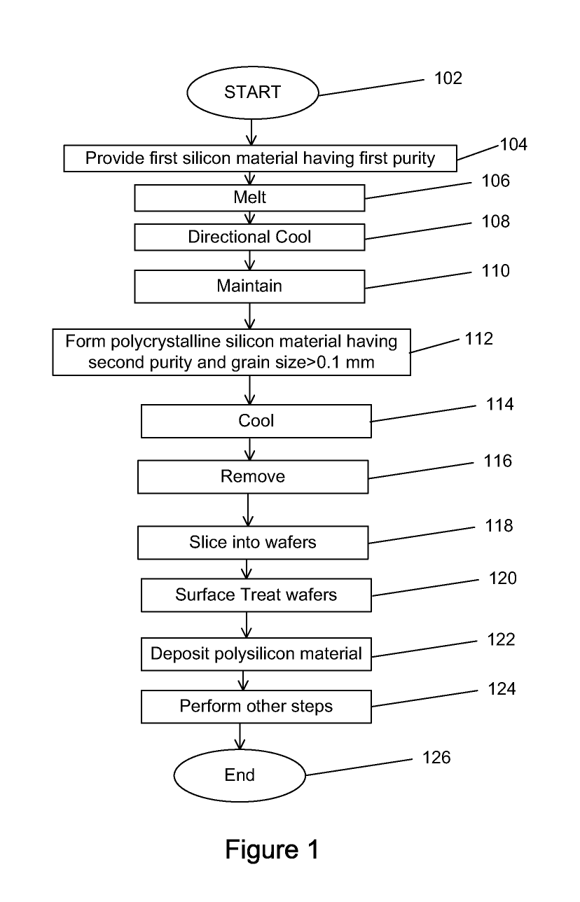

FIG. 1 is a simplified process flow diagram 100 illustrating a method for forming a polysilicon material for photovoltaic cells according to an embodiment of the present invention. As shown, the method begins with a start step (Step 102). The method provides a first silicon material characterized by a solid state and a first purity level (Step 104). The first silicon material provided in a first spatial volume and subjected to a thermal process to cause the silicon material to transform to a molten state (Step 106). The method transfers and dispenses the molten first silicon material into second spatial volume provided by a directional cooling vessel (Step 108). The method performs a directional cooling process by removing thermal energy from a first spatial region of the second spatial volume. The molten silicon material is maintained within the directional vessel for a predetermined period (Step 110). A polycrystalline silicon material characterized by a second purity level and a grain size greater than 0.1 mm is formed from the molten first silicon material in a vicinity of the first region (Step 112). The first silicon material is allowed to cooled using a cooling profile or a predetermine cooling rate (Step 114). The polycrystalline silicon material is removed from the directional cooling vessel after cooling (Step 116) for further processing. In certain embodiments, the polycrystalline silicon material is cut and sliced into one or more silicon wafers (Step 118). The one or more silicon wafers include a surface region. The method subjects the surface region of each silicon wafer to a surface treatment process (Step 120). In a specific embodiment, the surface treatment process includes a chemical etching (or polishing) process and a chemical leaching process. In a specific embodiment, a polysilicon film material is deposited overlying the surface region (Step 122). The polysilicon film material is characterized by a large grain size, for example, greater than about 0.1 mm, suitable for photovoltaic cells. The method performs other steps (Step 124) as desired. The method stops at an end step (Step 126). Of course there can be other variations, modifications, and alternatives.

The above sequence of steps provides a method of forming a polysilicon material having a large grain size according to an embodiment of the present invention. As shown, the method uses a combination of steps including a way of forming a large grain polysilicon material overlying a polycrystalline silicon substrate in a specific embodiment. Other variations and alterations can also be provided where one of more steps are added, one or more steps are removed, or one or more steps are provided in a different sequence without departing from the scope of claims therein. One skilled in the art would recognize many other variations, modifications, and alternatives.

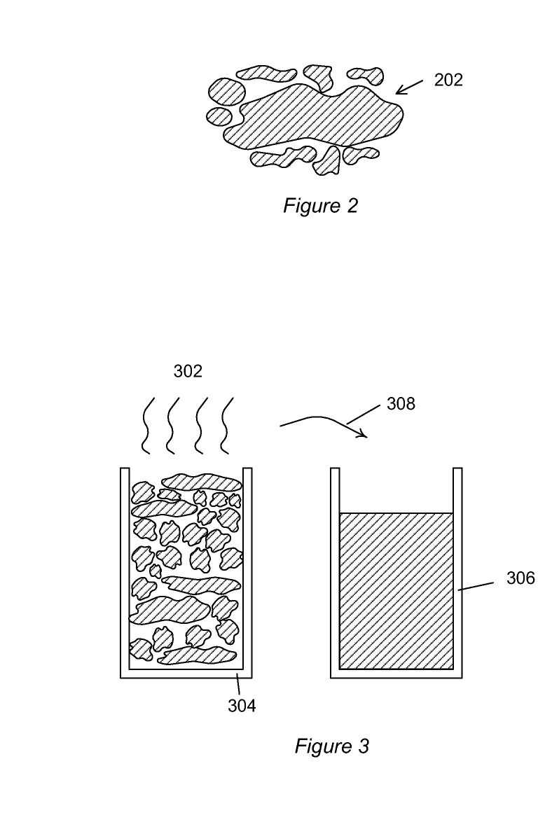

FIGS. 2-8 are simplified diagrams illustrating a method of forming a large grain (for example, greater than about 0.1 mm) polysilicon film material according to an embodiment of the present invention. As shown, the method provides a plurality of a first silicon material 202. The silicon material is characterized by a solid state and a first purity level. The first silicon material can be a metallurgical grade silicon having a purity of about 2N (0.99 pure). The first silicon material can also be a chemical grade silicon having a purity greater than about 3N (0.999 pure). The first silicon material can have other purity grades, for example, solar grade or semiconductor grade, depending on the embodiment. The silicon material can be provided in chunks or pieces of various sizes. Of course there can be other variations, modifications, and alternatives.

In a specific embodiment, the method includes subjecting the plurality of first silicon material to a thermal process in a first spatial volume 304. In a specific embodiment, the thermal process is provided in a first temperature range. The first temperature range is preferably greater than about a melting temperature of the first silicon material, for example at or greater than about 1410 Degree Celsius. Preferably the first temperature range is greater than about 1550 Degree Celsius to compensate for any heat loss during a transferring process. In a specific embodiment, the thermal process can be provided using an arc furnace or a high frequency inductive furnace, or a medium frequency inductive furnace, and the like. After melting, the first silicon material is transferred 308 to a second spatial volume 306. In a specific embodiment, the second spatial volume is provided by a directional cooling vessel to provide for a directional cooling process.

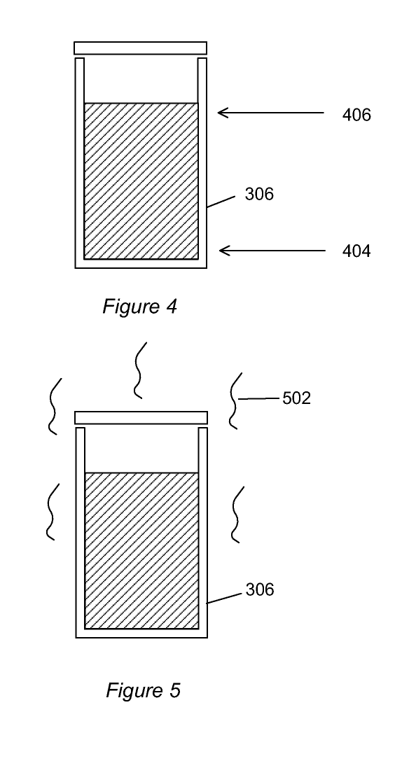

As shown in FIG. 4, the second spatial volume includes a first spatial region 404. The method includes removing thermal energy from the molten first silicon material within the first spatial region to cause a thermal gradient within the second spatial volume between the first spatial region and a second spatial region 406. In specific embodiment, the thermal gradient is characterized by a first temperature at the first spatial region and a second temperature at the second spatial region. The second temperature is higher than a melting temperature of the first silicon material, for example greater than about 1410 Degree Celsius and preferably greater than about 1570 Degree Celsius. The first region is maintained at a first temperature. The first temperature is lower than the melting temperature of the first silicon material. For example, the first temperature can be less than about 1410 Degree Celsius. In a specific embodiment, the first temperature and the second temperature can differ by about 100 degrees to about 200 degrees to provide for a controlled cooling of the first silicon material in the first spatial region. In a specific embodiment, the directional cooling process is performed for a predetermined time period greater than about eight hours. In an alternative embodiment, the predetermined time period can be ranging from about ten hours to about 24 hours. In certain embodiments, the predetermined time period can be greater than about 48 hours. In a specific embodiment, after the directional cooling process, the first silicon material is subjected to a controlled cooling process to cool the first silicon material to about room temperature. The controlled cooling process can use a cooling rate ranging from about 10 degrees per hour to 100 degrees per hour. The controlled cooling process may also use a cooling profile depending on the embodiment. Of course there can be other variations, modifications, and alternatives.

In a specific embodiment, after the directional cooling process, the silicon material is allowed to cool to about room temperature by a cooling process 502 as shown in FIG. 5. The cooling process can be provided as a controlled cooling process provided at a predetermined cooling rate ranging from five Degree per hour to about 200 Degree per hour in a specific embodiment. In certain embodiment, the controlled cooling process can be provided at a cooling rate ranging from 10 Degree per hour to about 100 Degree per hour. The controlled cooling process can also be provided using a suitable cooling profile for a second predetermined time period. In a specific embodiment, the second predetermined time period can be greater than about 15 hours. In a preferred embodiment, the second predetermined time can be greater than about 24 hours and preferably ranging from about 30 to about 60 hours. Of course there can be other variations, modifications, and alternatives.

Optionally, an impurity species can be added to the molten first silicon material to cause the first silicon material to have a suitable conductive type and a suitable conductivity. For example, a boron species or a gallium species may be added to the molten first silicon material to form a P type silicon material. Alternatively, a N type silicon material may be formed by adding a phosphorus species, or an arsenic species, or an antimony species to the molten first silicon material. In certain embodiments, the first silicon material can be heavily doped to have a resistivity less than about 0.5 ohm cm⁻¹ to provide for a conductor like characteristics. Of course there can be other variations, modifications, and alternatives.

Effectively, the directional cooling process causes impurities such as metal impurities to preferentially remain in silicon material in the second spatial region. In a specific embodiment, the directional cooling process and the cooling process cause formation of a solid polycrystalline silicon material from the molten first silicon material in a vicinity of the first region. The solid polycrystalline silicon material is characterized by an average grain size greater than about 0.1 mm and a second purity level in a specific embodiment. Depending upon the first purity level, the second purity level can be at least 10 percent better than the first purity level. For example, for a first purity of 2N (0.99 pure silicon), the second purity after direction cooling and cooling, can be better than 3N (0.999 pure silicon). Of course there can be other variations, modifications, and alternatives.

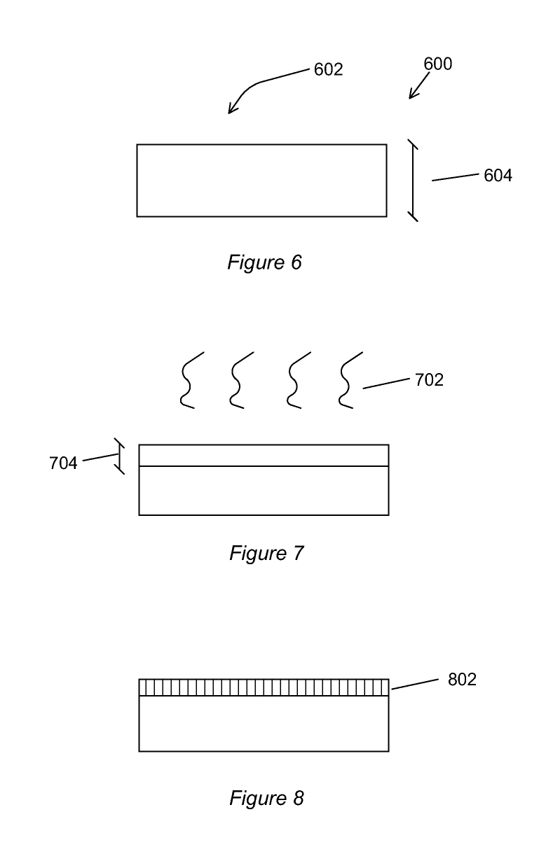

After cooling, the polycrystalline silicon material is removed from the directional cooling vessel for further processing. In a specific embodiment, the second silicon material is cut and sliced into one or more silicon wafers 600 as shown in FIG. 6. Each of the silicon wafer can have various shapes and sizes depending on the application. For example, the silicon wafer can be squares having truncated corners and having a dimension of 125 mm by 125 mm, 156 mm by 156 mm, 210 mm by 210 mm, but can be others. Alternatively, the silicon wafers can be circular having diameters up to 300 mm, or others. The silicon wafer can have a thickness 604 ranging from about 100 microns to a few millimeters depending on the embodiment. The silicon wafer can also be provided as a large area substrate having dimension greater than about 0.5 meter by 0.5 meter. As shown, each of the silicon wafers includes a first surface region 602. The first surface region can have surface features and defects that are not suitable for deposition processes. Accordingly, the first surface region of the silicon wafer is subjected to one or more surface treatment process 702 as shown in FIG. 7. In a specific embodiment, the surface treatment process includes a chemical etching process. The chemical etching process can use a acid mixture such as a mixture of nitric acid (HNO₃) and hydrofluoric acid (HF). Depending on the embodiment, other acids or acid mixtures may also be used. In an alternate embodiment, the chemical etching process can use an alkali such as a potassium hydroxide (KOH) solution. In certain embodiments, the surface etching process may be provided at a temperature ranging from about 45 Degree Celsius to about 60 Degree Celsius. The surface etching process removes surface irregularities and surface roughness providing a smooth surface and exposing crystal planes of the silicon material. Of course there can be other variations, modifications, and alternatives.

In a specific embodiment, after the chemical etching process, the surface region is further subjected to a chemical leaching process. The chemical leaching process removes contaminants such as metals from a depth of silicon material 704 in a vicinity of the surface region. In a specific embodiment, the chemical leaching process uses a combination of acids including hydrochloric acid (HCl) and nitric acid (HNO₃) to remove contaminants from the depth of silicon material in a vicinity of the surface region. The silicon wafer is usually subjected to a cleaning process before further processing. The cleaning process can include an RCA clean followed by rinsing using a high purity deionized water to remove residual acid or other chemicals from the wafer. Of course there can be other variations, modifications, and alternatives.

In a specific embodiment, the surface treatment process provides a silicon surface region that is suitable for deposition of a polysilicon material 802. In a specific embodiment, the polysilicon material can be deposited using an epitaxial growth process using precursors such as chlorosilanes, for example, tetrachlorosilane (SiCl₄), trichlorosilane (SiHCl₃), dichlorosilane (SiH₂Cl₂), monochlorosilane (SiH₃Cl) and hydrogen as a reducing agent but can be others. Other precursors may also be used. These other precursors may include silane (SiH₄) or other suitable precursors depending on the embodiment. Deposition temperature can range from about 900 Degree Celsius to about 1150 Degree Celsius depending on the precursor used. Other deposition techniques can include chemical vapor deposition (CVD) or physical vapor deposition (PVD) depending on the embodiment. In a specific embodiment, the polysilicon material is characterized by a grain size greater than about 0.1 mm. Depending on the application, the polysilicon material can have a thickness greater than about 50 microns. Additionally the polysilicon material is characterized by a carrier life time greater than about 1 millisecond in a preferred embodiment. Of course there can be other variations, modifications, and alternatives.

In a specific embodiment, the polysilicon material may be doped to have a first conductive type using a suitable impurity species. For example, the polysilicon material may be doped to have a P type impurity characteristic using a boron species. The polysilicon material may also be doped using an N type impurity species. The N type impurity species may include phosphorus, arsenic, antimony, or others. In a specific embodiment, an impurity of a second conductive type opposite to that of the first conductive type, is provided in a surface region of the polysilicon to cause formation of a pn junction for a photovoltaic cell. Of course there can be other variations, modifications, and alternatives.

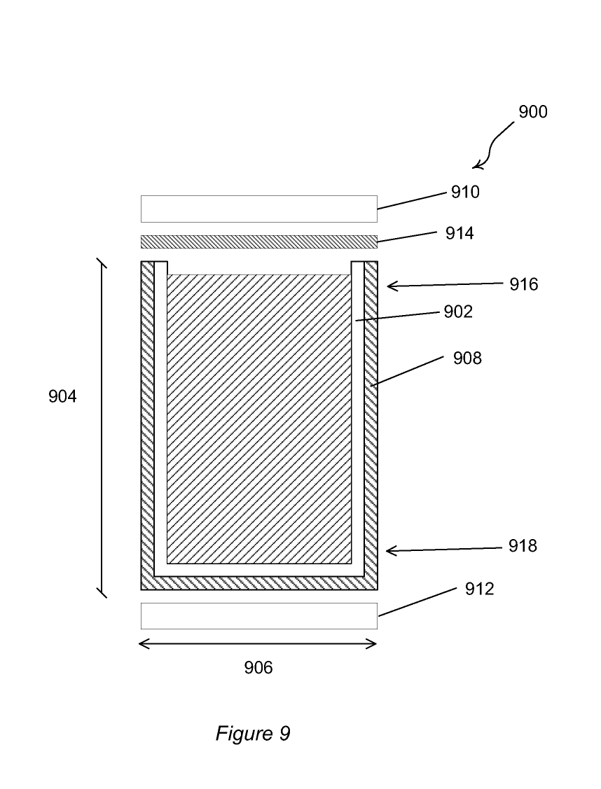

FIG. 9 is a simplified diagram illustrating a directional cooling vessel 900 according to an embodiment of the present invention. As shown, the directional cooling vessel includes a crucible 902. The crucible can be made of a quartz material or a fused silica material in a specific embodiment. Other materials may also be used, for example, graphite, ceramic and others, depending on the application. The crucible has a height 904 and a cross section 906. The crucible can have various shapes and sizes. In certain embodiment, the crucible can have a large rectangular cross sectional area to provide for a large area silicon wafer material or a large area silicon substrate, for example greater than 0.5 m×0.5 m. In other embodiments, the crucible can have a circular cross section having diameters up to 300 mm or greater. Also shown, the directional cooling vessel includes a support member 908 for the crucible. The support member maintains the shape of the crucible should the crucible material softens at high temperatures. In a specific embodiment, the support member can use graphite plates which has sufficient rigidity at high temperatures. Other suitable materials may also be used for the supporting element. These other suitable materials may include ceramic material and others. Depending on the embodiment, the directional cooling vessel can also include a cover member 914 for the crucible to shield the silicon material in the crucible from ambient impurities. Of course there can be other variations, modifications, and alternatives.

Referring again to FIG. 9, the directional cooling vessel includes a first heating element 910 provided at vicinity to the first spatial region 916 of the crucible and a second heating element 912 provided at a vicinity to second spatial region 918 of the crucible in a specific embodiment. The first heating element maintains the first silicon material within a first spatial volume at the first temperature range and the second heating element maintains the second temperature at the second spatial region to cause a thermal gradient in a specific embodiment. The first temperature is greater than a melting temperature of the silicon material. In a specific embodiment, the first temperature can range from about 1410 Degree Celsius to about 1600 Degree Celsius and the second temperature is maintained at a temperature lower than the first temperature. In a specific embodiment, the second temperature is lower than the melting temperature of the silicon material. For example, the second temperature can be less than about 1410 Degree Celsius to about room temperature. Depending on the embodiment, the second temperature can be 10 Degrees to 200 Degrees lower than the first temperature to provide for a controlled directional cooling for the silicon material. Of course there can be other variations, modifications, and alternatives.

In an alternative embodiment, the first temperature, the second temperature, and the temperature difference between the first temperature and the second temperature may be maintained using one or more insulation elements surrounding the directional cooling vessel. The insulating elements are positioned such that a predetermined difference in the temperature in the first spatial region and the second spatial region is maintained. For example, a portion of the second spatial region can be left un-insulated to maintain the difference in temperature between the first spatial region and the second spatial region. Alternatively, the directional cooling vessel can be thermally insulated to various degrees to maintain the temperature difference between the first spatial region and the second spatial region. The second spatial region can be more thermally insulated using for example, a thicker insulating material while the insulating material is less thick surrounding the first spatial region. Of course there can be other variations, modifications, and alternatives.

Optionally, the polycrystalline silicon material may be further subjected to an anneal process provided at a temperature ranging from about 1300 Degree Celsius to about 1400 Degree Celsius to improve a grain characteristics of the polycrystalline silicon material. The anneal process can be provided in a time period of about 3 hour to about five hours. Of course there can be other variations, modifications, and alternative.

It is also understood that the examples and embodiments described herein are for illustrative purposes only and that various modifications or alternatives in light thereof will be suggested to persons skilled in the art and are to be included within the spirit and purview of this application and scope of the appended claims.

What is claimed is:

1. A method for forming polysilicon film material for manufacturing photovoltaic cells, comprising:
providing a plurality of first silicon material characterized by a solid state, the first silicon material having a first purity;
subjecting the plurality of first silicon materials to a thermal process at a first temperature range to cause the first silicon material to transform from the solid state to a molten state confined within a first spatial volume, the first temperature range including a first temperature greater than a melting point temperature of the plurality of first silicon materials;
transferring the first silicon material in the molten state to a second spatial volume, the second spatial volume being provided using a directional cooling vessel;
removing thermal energy from a first spatial region of the directional cooling vessel at a first rate using a cooling process to cause a thermal gradient along a spatial volume of the directional vessel between the first spatial region to a second spatial region, the thermal gradient being characterized by a first temperature at the first spatial region and a second temperature at the second spatial region at a determined time;
forming a solid polycrystalline silicon material from a portion of the molten state at a vicinity of the first spatial region, the solid polycrystalline silicon material having a second purity level and an average grain size greater than about 0.1 mm;
forming one or more silicon wafers from the polycrystalline silicon material, each of the silicon wafer including a surface region;
subjecting the silicon wafer to one or more surface treatment process; and
forming a polysilicon film material overlying the surface region using a deposition process, the polysilicon film being characterized by a grain size greater than about 0.1 mm.

2. The method of claim 1 wherein the thermal process is provided using a arc furnace, or a high frequency inductive furnace, or a medium frequency inductive furnace.

3. The method of claim 1 wherein the first purity level is greater than about 1N (0.9 pure silicon).

4. The method of claim 1 wherein the thermal gradient is maintained for greater than about four hours.

5. The method of claim 1 wherein the solid polycrystalline silicon material is characterized by a second purity level greater than the first purity level in a solidification process.

6. The method of claim 1 further comprises a controlled cooling process provided at a cooling rate of about five Degree per hour to about 200 Degree per hour.

7. The method of claim 1 wherein the second purity level is higher than the first purity level by greater than about 10 percent.

8. The method of claim 1 wherein second temperature is maintained at a temperature ranging from about 1420 Degree Celsius to about 1600 Degree Celsius.

9. The method of claim 1 wherein the first temperature is maintained at temperature ranging from room temperature to about 1410 Degree Celsius.

10. The method of claim 1 further comprises an annealing process provided at a temperature ranging from about 1300 Degree Celsius to about 1400 Degree Celsius for greater than about three hours.

11. The method claim 1 wherein the polysilicon film material is characterized by a carrier life time greater than about 1 microseconds.

12. The method of claim 1 further allowing the first silicon material to cool at a predetermined cooling rate.

13. The method of claim 1 wherein the directional cooling vessel is provided using material selected from: graphite, quartz, silicon carbide or a ceramic.

14. The method of claim 1 further providing a cooling process after the directional cooling process for greater than about one hour.

15. The method of claim 1 wherein the surface treatment process comprises a chemical etch process and a chemical leaching process.

16. The method of claim 15 wherein the chemical etch process removes surface irregularities and surface roughness from the surface region of the silicon wafer.

17. The method of claim 15 wherein the chemical leaching process removes impurities from a depth in a vicinity of the surface region of the silicon wafer.

18. The method of claim 15 wherein the chemical etch process uses an acid, or an acid mixture, or an alkaline.

19. The method of claim 18 wherein the acid mixture comprises a mixture of nitric acid (HNO₃) and hydrofluoric acid (HF).

20. The method of claim 18 wherein the alkaline comprises potassium hydroxide solution.

21. The method of claim 15 wherein the chemical leaching process uses a mixture of acids comprising hydrochloric acid and nitric acid.

22. The method of claim 1 wherein the silicon wafer has a thickness greater than about 100 microns.

23. An apparatus for forming silicon material for photovoltaic devices, comprising:
a directional cooling vessel, comprising:
a crucible having a first spatial volume including a height;
a first heating element provided external to the first spatial volume of the crucible in a vicinity to a first spatial region in a vicinity to the first end of the height, the first heating element maintaining a first temperature range in the first spatial region of the first spatial volume and a second temperature range in a second spatial region of the first spatial volume, wherein
the first temperature range comprising a first temperature greater than about a melting temperature of a silicon material and
the first temperature range and the second temperature range cause a temperature gradient along the spatial volume between the first spatial region and the second spatial region.

24. The apparatus of claim 23 wherein the directional cooling vessel further comprises a second heating element provided at the second end of the height to maintain the second temperature in the second spatial region.

25. The apparatus of claim 23 wherein the temperature gradient is provided using one or more insulating members.

26. The apparatus of claim 23 wherein the first temperature ranges from about 1420 Degree Celsius to about 1600 Degree Celsius.

27. The apparatus of claim 23 wherein the second temperature ranges from about room temperature to about a temperature lower than about the melting temperature of the silicon material.

28. The apparatus of claim 23 wherein the directional cooling vessel comprises one or more insulating element surrounding the crucible including the heating elements, the one or more insulating elements provide the first temperature range and the second temperature range.

29. The apparatus of claim 23 wherein the crucible uses quartz or fused silica.

30. The apparatus of claim 23 wherein the crucible is further supported by a support member comprising graphite plates or ceramic plates.

31. The apparatus of claim 23 wherein the first temperature is higher than the second temperature by about five to about 200 Degrees.
